(19) United States
(12) Patent Application Publication
(10) Pub. No.: US 2012/0078625 A1
(43) Pub. Date: Mar. 29, 2012

(54) WAVEFORM ANALYSIS OF SPEECH

(75) Inventor: Michael A. Stokes, Indianapolis, IN (US)

(73) Assignee: WAVEFORM COMMUNICATIONS, LLC, Indianapolis, IN (US)

(21) Appl. No.: 13/241,780

(22) Filed: Sep. 23, 2011

Related U.S. Application Data
(60) Provisional application No. 61/385,638, filed on Sep. 23, 2010.

(51) Int. Cl. G10L 15/20; G10L 15/04

(52) U.S. Cl. 704/233; 704/254; 704/E15.001

(57) ABSTRACT

A waveform analysis of speech is disclosed. Embodiments include methods for analyzing captured sounds produced by animals, such as human vowel sounds, and accurately determining the sound produced. Some embodiments utilize computer processing to identify the location of the sound within a waveform, select a particular time within the sound, and measure a fundamental frequency and one or more formants at the particular time. Embodiments compare the fundamental frequency and the one or more formants to known thresholds and multiples of the fundamental frequency, such as by a computer-run algorithm. The results of this comparison identify of the sound with a high degree of accuracy.

This application claims the benefit of U.S. Provisional Application No. 61/385,638, filed Sep. 23, 2010, the entirety of which is hereby incorporated herein by reference. Any disclaimer that may have occurred during the prosecution of the above-referenced application is hereby expressly rescinded.

### FIELD

Embodiments of this invention relate generally to a analysis of sounds, such as the automated analysis of words, a particular example being the automated analysis of vowel sounds.

### BACKGROUND

Sound waves are developed as a person speaks. Generally, different people produce different sound waves as they speak, making it difficult for automated devices, such as computers, to correctly analyze what is being said. In particular, the waveforms of vowels have been considered by many to be too intricate to allow an automated device to accurately identify the vowel.

### SUMMARY

Embodiments of the present invention provide an improved an improved waveform analysis of speech.

Improvements in vowel recognition can dramatically improve the speed and accuracy of devices adapted to correctly identify what a talker is saying or has said. Certain features of the present system and method address these and other needs and provide other important advantages.

In accordance with one aspect, a method for identifying sounds, for example vowel sounds, is disclosed. In alternate embodiments, the sound is analyzed in an automated process (such as by use of a computer performing processing functions according to a computer program, which generally avoids subjective analysis of waveforms and provide methods that can be easily replicated), or a process in which at least some of the steps are performed manually.

In accordance with still other aspects of embodiments of the present invention, a waveform model for analyzing sounds, such as uttered sounds, and in particular vowel sounds produced by humans, is disclosed. Aspects include the categorization of the vowel space and identifying distinguishing features for categorical vowel pairs. From these categories, the position of the lips and tongue and their association with specific formant frequencies are analyzed, and perceptual errors are identified and compensated. Embodiments include capture and automatic analysis of speech waveforms through, e.g., computer code processing of the waveforms. The waveform model associated with embodiments of the invention utilizes a working explanation of vowel perception, vowel production, and perceptual errors to provide unique categorization of the vowel space, and the ability to accurately identify numerous sounds, such as numerous vowel sounds.

In accordance with other aspects of embodiments of the present system and method, a sample location is chosen within a sound (e.g., a vowel) to be analyzed. A fundamental frequency (F0) is measured at this sample location. Measurements of one or more formants (F1, F2, F3, etc.) are performed at the sample location. These measurements are compared to known values of the fundamental frequency and one or more of the formants for various known sounds, with the results of this comparison resulting in an accurate identification of the sound. These methods can increase the speed and accuracy of voice recognition and other types of sound analysis and processing.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein is not necessarily intended to address every object described herein, and each embodiment does not necessarily include each feature described. Other forms, embodiments, objects, advantages, benefits, features, and aspects of the present system and method will become apparent to one of skill in the art from the description and drawings contained herein. Moreover, the various apparatuses and methods described in this summary section, as well as elsewhere in this application, can be embodied in a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

FIG. 1 is a block diagram of a computing system adapted for waveform analysis of speech.

FIG. 2 is a schematic diagram of a computer used in various embodiments.

FIG. 3 is a graphical depiction of frequency versus time of the waveform in a sound file.

FIG. 4 is a graphical depiction of amplitude versus time in a portion of the waveform depicted in FIG. 3.

FIG. 5 is a graphical depiction of frequency versus time in a portion of the waveform depicted in FIG. 3.

FIG. 6 is a graphical representation of the waveform captured during utterance of a vowel by a first individual.

FIG. 7 is a graphical representation of the waveform captured during a different utterance of the same vowel as in FIG. 6 produced by the same individual as in FIG. 6.

FIG. 8 is a graphical representation of the waveform captured during an utterance of the same vowel depicted in FIGS. 6 and 7, but produced by a second individual.

FIG. 9 is a graphical representation of the waveform captured during an utterance of the same vowel depicted in FIGS. 6, 7, and 8, but produced by a third individual.

### DETAILED DESCRIPTION OF THE ILLUSTRATED EMBODIMENTS

For the purposes of promoting an understanding of the principles of the invention, reference will now be made to selected embodiments illustrated in the drawings and specific language will be used to describe the same. It will nevertheless be understood that no limitation of the scope of the invention is thereby intended; any alterations and further modifications of the described or illustrated embodiments, and any further applications of the principles of the invention as illustrated herein are contemplated as would normally occur to one skilled in the art to which the invention relates. At least one embodiment of the invention is shown in great detail, although it will be apparent to those skilled in the relevant art that some features or some combinations of features may not be shown for the sake of clarity.

Any reference to “invention” within this document herein is a reference to an embodiment of a family of inventions, with no single embodiment including features that are necessarily included in all embodiments, unless otherwise stated. Further, although there may be references to “advantages” provided by some embodiments of the present invention, it is understood that other embodiments may not include those same advantages, or may include different advantages. Any advantages described herein are not to be construed as limiting to any of the claims.

Specific quantities (spatial dimensions, temperatures, pressures, times, force, resistance, current, voltage, concentrations, wavelengths, frequencies, heat transfer coefficients, dimensionless parameters, etc.) may be used explicitly or implicitly herein, such specific quantities are presented as examples only and are approximate values unless otherwise indicated. Discussions pertaining to specific compositions of matter are presented as examples only and do not limit the applicability of other compositions of matter, especially other compositions of matter with similar properties, unless otherwise indicated.

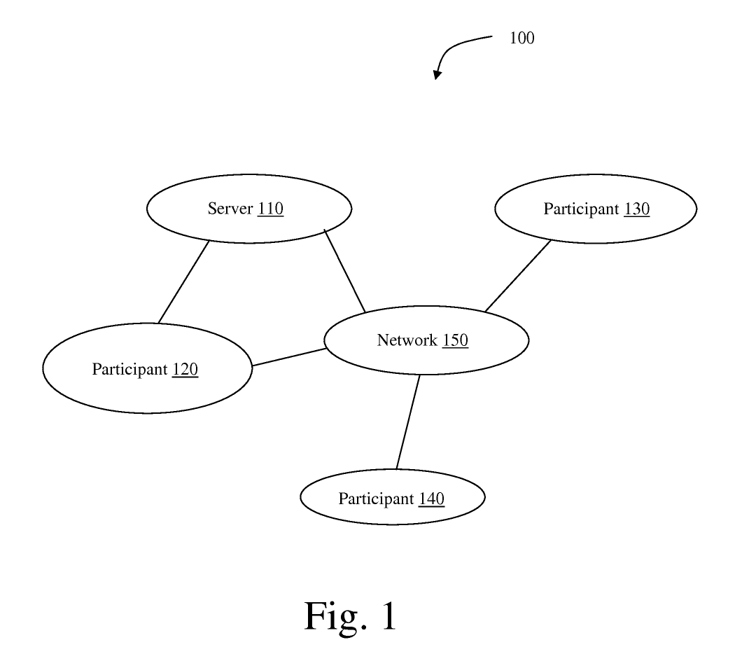

FIG. 1 illustrates various participants in system 100, all connected via a network 150 of computing devices. Some participants, e.g., participant 120, may also be connected to a server 110, which may be of the form of a web server or other server as would be understood by one of ordinary skill in the art. In addition to a connection to network 150, participants 130 and 140 may each have data connections, either intermittent or permanent, to server 110. In many embodiments, each computer will communicate through network 150 with at least server 110. Server 110 may also have data connections to additional participants as will be understood by one of ordinary skill in the art.

Certain embodiments of the present system and method relate to analysis of spoken communication. More specifically, particular embodiments relate to using waveform analysis of vowels for vowel identification and talker identification, with applications in speech recognition, hearing aids, speech recognition in the presence of noise, and talker identification. It should be appreciated that “talker” can apply to humans as well as other animals that produce sounds.

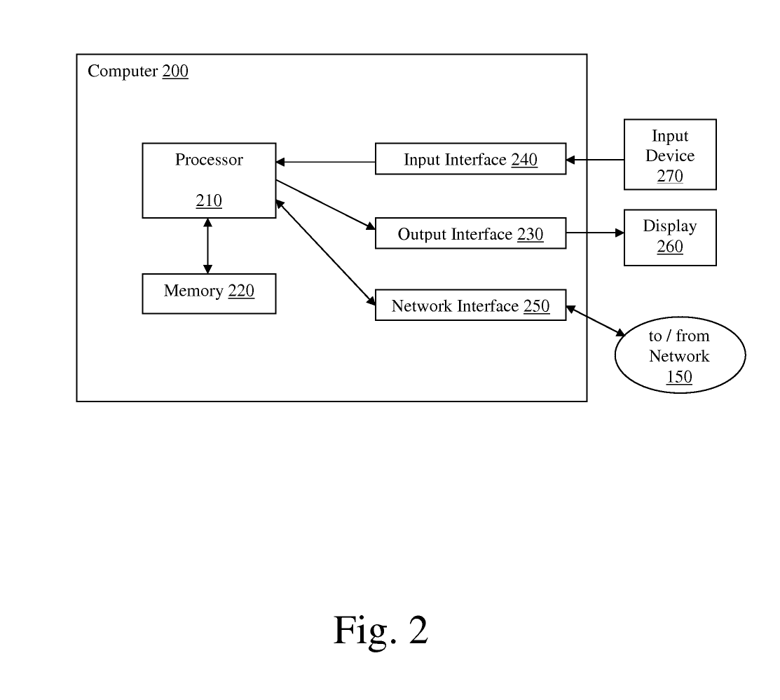

The computers used as servers, clients, resources, interface components, and the like for the various embodiments described herein generally take the form shown in FIG. 2. Computer 200, as this example will generically be referred to, includes processor 210 in communication with memory 220, output interface 230, input interface 240, and network interface 250. Power, ground, clock, and other signals and circuitry are omitted for clarity, but will be understood and easily implemented by those skilled in the art.

With continuing reference to FIG. 2, network interface 250 in this embodiment connects computer 200 to a data network (such as a direct or indirect connection to server 110 and/or network 150) for communication of data between computer 200 and other devices attached to the network. Input interface 240 manages communication between processor 210 and one or more input devices 270, for example, microphones, pushbuttons, UARTs, IR and/or RF receivers or transceivers, decoders, or other devices, as well as traditional keyboard and mouse devices. Output interface 230 provides a video signal to display 260, and may provide signals to one or more additional output devices such as LEDs, LCDs, or audio output devices, or a combination of these and other output devices and techniques as will occur to those skilled in the art.

Processor 210 in some embodiments is a microcontroller or general purpose microprocessor that reads its program from memory 220. Processor 210 may be comprised of one or more components configured as a single unit. Alternatively, when of a multi-component form, processor 210 may have one or more components located remotely relative to the others. One or more components of processor 210 may be of the electronic variety including digital circuitry, analog circuitry, or both. In one embodiment, processor 210 is of a conventional, integrated circuit microprocessor arrangement, such as one or more CORE 2 QUAD processors from INTEL Corporation of 2200 Mission College Boulevard, Santa Clara, Calif. 95052, USA, or ATHLON or PHENOM processors from Advanced Micro Devices, One AMD Place, Sunnyvale, Calif. 94088, USA, or POWER6 processors from IBM Corporation, 1 New Orchard Road, Armonk, N.Y. 10504, USA. In alternative embodiments, one or more application-specific integrated circuits (ASICs), reduced instruction-set computing (RISC) processors, general-purpose microprocessors, programmable logic arrays, or other devices may be used alone or in combination as will occur to those skilled in the art.

Likewise, memory 220 in various embodiments includes one or more types such as solid-state electronic memory, magnetic memory, or optical memory, just to name a few. By way of non-limiting example, memory 220 can include solid-state electronic Random Access Memory (RAM), Sequentially Accessible Memory (SAM) (such as the First-In, First-Out (FIFO) variety or the Last-In First-Out (LIFO) variety), Programmable Read-Only Memory (PROM), Electrically Programmable Read-Only Memory (EPROM), or Electrically Erasable Programmable Read-Only Memory (EEPROM); an optical disc memory (such as a recordable, rewritable, or read-only DVD or CD-ROM); a magnetically encoded hard drive, floppy disk, tape, or cartridge medium; or a plurality and/or combination of these memory types. Also, memory 220 is volatile, nonvolatile, or a hybrid combination of volatile and nonvolatile varieties. Memory 220 in various embodiments is encoded with programming instructions executable by processor 210 to perform the automated methods disclosed herein.

The Waveform Model of Vowel Perception and Production (systems and methods implementing and applying this teaching being referred to herein as “WM”) includes, as part of its analytical framework, the manner in which vowels are perceived and produced. It requires no training on a particular talker and achieves a high accuracy rate, for example, 97.7% accuracy across a particular set of samples from twenty talkers. The WM also associates vowel production within the model, relating it to the entire communication process. In one sense, the WM is an enhanced theory of the most basic level (phoneme) of the perceptual process.

The lowest frequency in a complex waveform is the fundamental frequency (F0). Formants are frequency regions of relatively great intensity in the sound spectrum of a vowel, with F1 referring to the first (lowest frequency) formant, F2 referring to the second formant, and so on. From the average F0 (average pitch) and F1 values, a vowel can be categorized into one of six main categories by virtue of the relationship between F1 and F0. The relative categorical boundaries can be established by the number of F1 cycles per pitch period, with the categories depicted in Table 1 determining how a vowel is first assigned to a main vowel category.

TABLE 1
Vowel Categories

| | |
|---|---|
| Category 1: | 1 < F1 cycles per F0 < 2 |
| Category 2: | 2 < F1 cycles per F0 < 3 |
| Category 3: | 3 < F1 cycles per F0 < 4 |
| Category 4: | 4 < F1 cycles per F0 < 5 |
| Category 5: | 5.0 < F1 cycles per F0 < 5.5 |
| Category 6: | 5.5 < F1 cycles per F0 < 6.0 |

Each main category consists of a vowel pair, with the exception of Categories 3 and 6, which have only one vowel. Once a vowel waveform has been assigned to one of these categories, further identification of the particular vowel sound generally requires a further distinction between the vowel pairs.

One vowel of each categorical pair (in Categories 1, 2, 4, and 5) has a third acoustic wave present, while the other vowel of the pair does not. The presence of F2 in the range of 2000 Hz can be recognized as this third wave, while F2 values in the range of 1000 Hz might be considered either absence of the third wave or presence of a different third wave. Since each main category has one vowel with F2 in the range of 2000 Hz and one vowel with F2 in the range of 1000 Hz (see Table 2), F2 frequencies provide an easily distinguished feature between the categorical vowel pairs in these categories. In one sense, this can be analogous to the distinguishing feature between the stop consonants /b/-/p/, /d/-/t/, and /g/-/k/, the presence or absence of voicing. F2 values in the range of 2000 Hz being analogous to voicing being added to /b/, /d/, and /g/, while F2 values in the range of 1000 Hz being analogous to the voiceless quality of the consonants /p/, /t/, and /k/. The model of vowel perception described herein was developed, at least in part, by considering this similarity with an established pattern of phoneme perception.

TABLE 2
Waveform Model Organization of the Vowel Space

| Vowel-Category | F0 | F1 | F2 | F3 | (F1 − F0)/100 | F1/F0 |
|---|---|---|---|---|---|---|
| /i/-1 | 136 | 270 | 2290 | 3010 | 1.35 | 1.99 |
| /u/-1 | 141 | 300 | 870 | 2240 | 1.59 | 2.13 |
| /I/-2 | 135 | 390 | 1990 | 2550 | 2.55 | 2.89 |
| /U/-2 | 137 | 440 | 1020 | 2240 | 3.03 | 3.21 |
| /er/-3 | 133 | 490 | 1350 | 1690 | 3.57 | 3.68 |
| / [symbol] /-4 | 130 | 530 | 1840 | 2480 | 4.00 | 4.08 |
| / [symbol] /-4 | 129 | 570 | 840 | 2410 | 4.41 | 4.42 |
| /æ/-5 | 130 | 660 | 1720 | 2410 | 5.30 | 5.08 |
| / [symbol] /-5 | 127 | 640 | 1190 | 2390 | 5.13 | 5.04 |
| /a/-6 | 124 | 730 | 1090 | 2440 | 6.06 | 5.89 |

Identification of the vowel /er/ (the lone member of Category 3) can be aided by the observation of a third formant. However, the rest of the frequency characteristics of the wave for this vowel do not conform to the typical pair-wise presentation. This particular third wave is unique and can provide additional information that distinguishes /er/ from neighboring categorical pairs. The vowel /a/ (the lone member of Category 6), follows the format of Categories 1, 2, 4, and 5, but it does not have a high F2 vowel paired with it, possibly due to articulatory limitations.

Other relationships associated with vowels can also be addressed. As mentioned above, the categorized vowel space described above can be analogous to the stop consonants /b/-/p/, /d/-/t/, and /g/-/k/. To extend this analogy and the similarities, each categorical vowel pair can be thought of as sharing a common articulatory gesture that establishes the categorical boundaries. In other words, each vowel within a category can share an articulatory gesture that produces a similar F1 value since F1 varies between categories (F0 remains relatively constant for a given speaker). Furthermore, an articulatory difference between categorical pairs that produces the difference in F2 frequencies may be identifiable, similar to the addition of voicing or not by vibrating the vocal folds. The following section organizes the articulatory gestures involved in vowel production by the six categories identified above in Table 1.

From Table 3, it can be seen that a common articulatory gesture between categorical pairs is tongue height. Each categorical pair shares the same height of the tongue in the oral cavity, meaning the air flow through the oral cavity is being unobstructed at the same height within a category. This appears to be the common place of articulation for each category as /b/-/p/, /d/-/t/, and /g/-/k/ share a common place of articulation. The tongue position also provides an articulatory difference within each category by alternating the portion of the tongue that is lowered to open the airflow through the oral cavity. One vowel within a category has the airflow altered at the front of the oral cavity, while the other vowel in a category has the airflow altered at the back. The subtle difference in the unobstructed length of the oral cavity determined by where the airflow is altered by the tongue (front or back) is a likely source of the 30 to 50 cps (cycles per second) difference between vowels of the same category. This may be used as a valuable cue for the system when identifying a vowel.

TABLE 3
Articulatory relationships

| Vowel- | Relative Tongue | | Relative Lip | |
|---|---|---|---|---|
| Category | Positions | F1 | Position | F2 |
| /i/-1 | high, front | 270 | unrounded, | 2290 |
| | | | spread | |
| /u/-1 | high, back | 300 | rounded | 870 |
| /I/-2 | mid-high, front | 390 | unrounded, | 1990 |
| | | | spread | |
| /U/-2 | mid-high, back | 440 | rounded | 1020 |
| /er/-3 | rhotacization | 490 | retroflex | 1350 |
| | | | | (F3 = 1690) |
| / [symbol] /-4 | mid, front | 530 | unrounded | 1840 |
| / [symbol] /-4 | mid, back | 570 | rounded | 840 |
| /æ/-5 | low, front | 660 | unrounded | 1720 |
| / [symbol] /-5 | mid-low, back | 640 | rounded | 1190 |
| /a/-6 | low, back | 730 | rounded | 1090 |

As mentioned above, there is a third wave (of relatively high frequency and low amplitude) present in one vowel of each categorical vowel pair that distinguishes it from the other vowel in the category. From Table 4, one vowel from each pair is produced with the lips rounded, and the other vowel is produced with the lips spread or unrounded. An F2 in the range of 2000 Hz appears to be associated with having the lips spread or unrounded.

By organizing the vowel space as described above, it is possible to predict errors in an automated perception system. The confusion data shown in Table 4 has Categories 1, 2, 4, and 5 organized in that order. Category 3 (/er/) is not in Table 4 because its formant values (placing it in the “middle” of the vowel space) make it unique. The distinct F2 and F3 values of /er/ may be analyzed with an extension to the general rule described below. Rather than distract from the general rule explaining confusions between the four categorical pairs, the acoustic boundaries and errors involving /er/ are discussed with the experimental evidence presented below. Furthermore, even though /a/ follows the general format of error prediction described below, Category 6 is not shown since /a/ does not have a categorical mate and many dialects have difficulty differentiating between /a/ and / [symbol] /.

WM predicts that errors generally occur across category boundaries, but only vowels having similar F2 values are generally confused for each other. For example, a vowel with an F2 in the range of 2000 Hz will frequently be confused for another vowel with an F2 in the range of 2000 Hz. Similarly, a vowel with F2 in the range of 1000 Hz will frequently be confused with another vowel with an F2 in the range of 1000 Hz. Vowel confusions are frequently the result of misperceiving the number of F1 cycles per pitch period. In this way, detected F2 frequencies limit the number of possible error candidates, which in some embodiments affects the set of candidate interpretations from which an automated transcription of the audio is chosen. (In some of these embodiments, semantic context is used to select among these alternatives.) Confusions are also more likely with a near neighbor (separated by one F1 cycle per pitch period) than with a distant neighbor (separated by two or more F1 cycles per pitch period). From the four categories shown in Table 4, 2,983 of the 3,025 errors (98.61%) can be explained by searching for neighboring vowels with similar F2 frequencies.

Turning to, the vowel /er/ in Category 3, it has a unique lip articulatory style when compared to the other vowels of the vowel space resulting in formant values that lie between the formant values of neighboring categories. This is evident when the F2 and F3 values of /er/ are compared to the other categories. Both the F2 and F3 values lie between the ranges of 1000 Hz to 2000 Hz of the other categories. With the lips already being directly associated with F2 values, the unique retroflex position of the lips to produce /er/ further demonstrates the role of the lips in F2 values, as well as F3 in the case of /er/. The quality of a unique lip position during vowel production produces a unique F2 and F3 value.

TABLE 4
Error Prediction

| Vowels | | | | | | | | |
|---|---|---|---|---|---|---|---|---|
| Intended | | | | | | | | |
| by | Vowels as Classified by Listener | | | | | | | |
| Speaker | /i/-/u/ | | /I/-/U/ | | / [symbol] /-/ [symbol] / | | /æ/-/ [symbol] / | |
| /i/ | 10,267 | — | 4 | — | 6 | 3 | — | — |
| /u/ | — | 10,196 | — | 78 | 1 | — | — | — |
| /I/ | 6 | — | 9,549 | — | 694 | 1 | 2 | — |
| /U/ | — | 96 | — | 9,924 | 1 | 51 | 1 | 171 |
| / [symbol] / | — | — | 257 | — | 9,014 | 3 | 949 | 2 |
| / [symbol] / | — | 5 | — | 71 | 1 | 9,534 | 2 | 62 |
| /æ/ | — | — | 1 | — | 300 | 2 | 9,919 | 15 |
| / [symbol] / | — | — | 1 | 103 | 1 | 127 | 8 | 9,476 |

The description of at least one embodiment of the present invention is presented in the framework of how it can be used to analyze a talker database, and in particular a talker data base of h-vowel-d (hVd) productions as the source of vowels analyzed for this study, such as the 1994 (Mullennix) Talker Database. The example database consists of 33 male and 44 female college students, who produced three tokens for each of nine American English vowels. The recordings were made using a Computerized Speech Research Environment software (CSRE) and converted to .wav files. Of the 33 male talkers in the database, 20 are randomly selected for use.

In this example, nine vowels are analyzed: /i/, /u/, /I/, /U/, /er/, /ε/, / [symbol] /, /æ/, /̂/. In most cases, there are three productions for each of the nine vowels used (27 productions per talker), but there are instances of only two productions for a given vowel by a talker. Across the 20 talkers, 524 vowels are analyzed and every vowel is produced at least twice by each talker.

In one embodiment, a laptop computer such as a COMPAQ PRESARIO 2100 is used to perform the speech signal processing. The collected data is entered into a database where the data is mined and queried. A programming language, such as Cold Fusion, is used to display the data and results. The necessary calculations and the conditional if-then logic are included within the program.

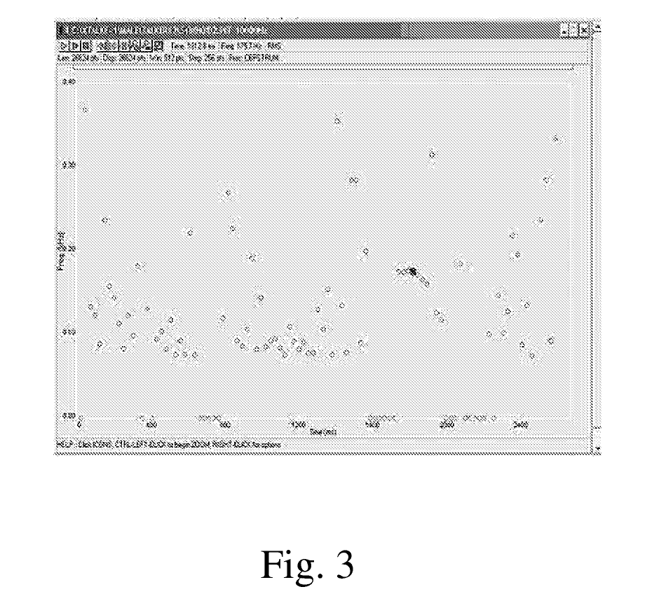

In one embodiment, the temporal center of each vowel sound is identified, and pitch and formant frequency measurements are performed over samples taken from near that center of the vowel. Analyzing frequencies in the temporal center portion of a vowel can be beneficial since this is typically a neutral and stable portion of the vowel. As an example, FIG. 3 depicts an example display of the production of “whod” by Talker 12. From this display, the center of the vowel can be identified. In some embodiments, the programming code identifies the center of the vowel. In one embodiment, the pitch and formant values are measured from samples taken within 10 ms of the vowel's center. In another embodiment, the pitch and formant values are measured from samples taken within 20 ms of the vowel's center. In still other embodiments, the pitch and formant values are measured from samples taken within 30 ms of the vowel's center, while is still further embodiments the pitch and formant values are measured from samples taken from within the vowel, but greater than 30 ms from the center.

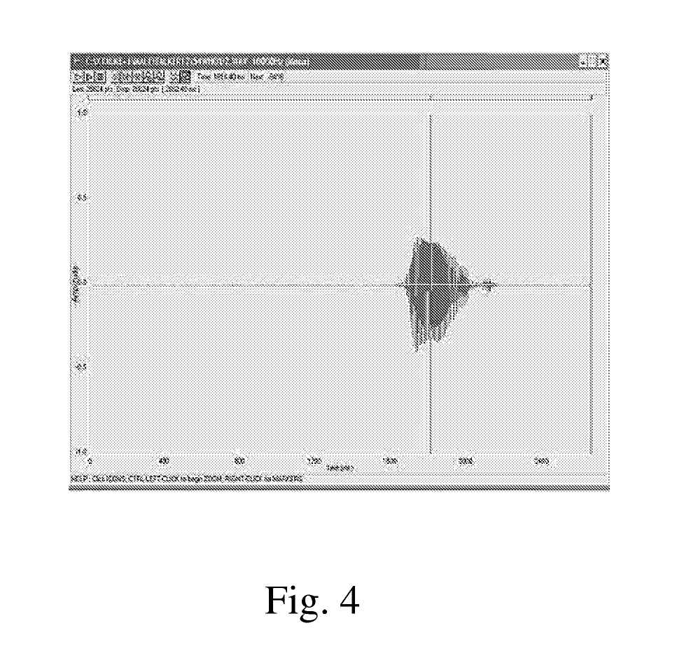

Once the sample time is identified, the fundamental frequency F0 is measured. In one embodiment, if the measured fundamental frequency is associated with an unusually high or low pitch frequency compared to the norm from that sample, another sample time is chosen and the fundamental frequency is checked again, and yet another sample time is chosen if the newly measured fundamental frequency is also associated with an unusually high or low pitch frequency compared to the rest of the central portion of the vowel. Pitch extraction is performed in some embodiments by taking the Fourier Transform of the time-domain signal, although other embodiments use different techniques as will be understood by one of ordinary skill in the art. FIG. 4 depicts an example pitch display for the “whod” production by Talker 12. Pitch measurements are made at the previously determined sample time. The sample time and the F0 value are stored in some embodiments for later use.

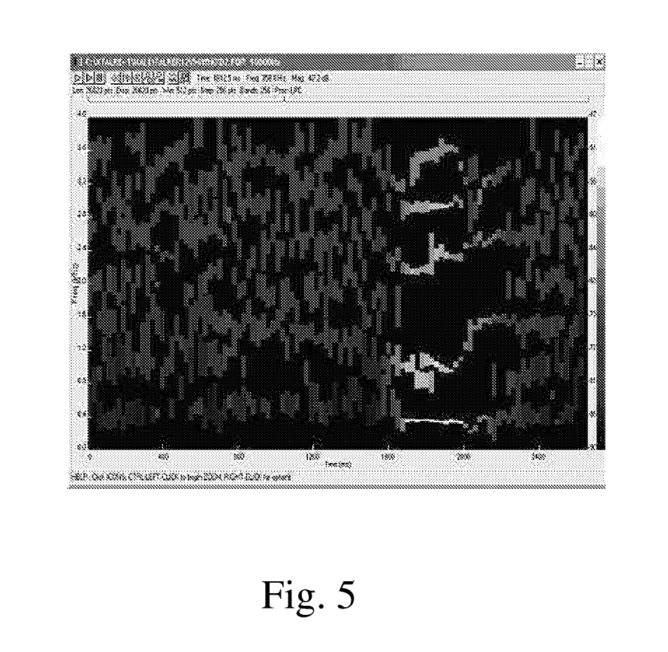

The F1, F2, and F3 frequency measurements are also made at the same sample time as the pitch measurement. FIG. 5 depicts an example display of the production of “whod” by Talker 12, which is an example display that can be used during the formant measurement process, although other embodiments measure formants without use of (or even making available) this type of display. The F1, F2, and F3 frequency measurements as well as the time and average pitch (F0 measurements) are stored in some embodiments before moving to the next vowel to be analyzed. For each production, the detected vowel's identity, the sample time for the measurements, and the F0, F1, F2, and F3 values can be stored, such as stored into a database.

By using F0 and F1 (and in particular embodiments the F1/F0 ratio) and the F1, F2, and F3 frequencies, vowel sounds can be automatically identified with a high degree of accuracy.

Table 5 depicts example ranges for F1/F0, F2 and F3 that enable a high degree of accuracy in identifying sounds, and in particular vowel sounds, and can be written into and executed by various forms of computer code. However, other ranges are contemplated within the scope of this invention. Some general guidelines that govern range selections of F1/F0, F2 and F3 in some embodiments include maintaining relatively small ranges of F1/F0, for example, ratio ranges of 0.5 or less. Smaller ranges generally result in the application of more detail across the sound (e.g., vowel) space, although processing time will increase somewhat with more conditional ranges to process. When using these smaller ranges, it was discovered that vowels from other categories tended to drift into what would be considered another categorical range. F2 values could continue to distinguish the vowels within each of these ranges, although it was occasionally prudent to make the F2 information more distinct in a smaller range. F1 serves in some embodiments as a cue to distinguish between the crowded ranges in the middle of the vowel space. If category boundaries are shifted, then as vowels drift into neighboring categorical ranges, F1 values assist in the categorization of the vowel since, in many instances, the F1 values appear to maintain a certain range for a given category regardless of the individual's pitch frequency.

The F1/F0 ratio is flexible enough as a metric to account for variations between talkers' F0 frequencies, and when arbitrary bands of ratio values are considered, the ratios associated with any individual vowel sound can appear in any of multiple bands. Some embodiments calculate the F0/F1 ratio first. F1 are calculated and evaluated next to refine the specific category for the vowel. F2 values are then calculated and evaluated to identify a particular vowel after its category has been selected based on the broad F1/F0 ratios and the specific F1 values. Categorizing a vowel with F1/F0 and F1 values and then using F2 as the distinguishing cue within a category as in some embodiments has been sufficient to achieve 97.7% accuracy in vowel identification.

In some embodiments F3 is used for /er/ identification in the high F1/F0 ratio ranges. However, in other embodiments F3 is used as a distinguishing cue in the lower F1/F0 ratios. Although F3 values are not always perfectly consistent, it was determined that F3 values can help differentiate sounds (e.g., vowels) at the category boundaries and help distinguish between sounds that might be difficult to distinguish based solely on the F1/F0 ratio, such as the vowel sounds /head/ and /had/.

TABLE 5
Waveform Model Parameters (conditional logic)

| Vowel | F1/F0 (as R) | F1 | F2 | F3 |
|---|---|---|---|---|
| /er/-heard | 1.8 < R < 4.65 | | 1150 < F2 < 1650 | F3 < 1950 |
| /i/-heed | R < 2.0 | | 2090 < F2 | 1950 < F3 |
| /i/-heed | R < 3.1 | 276 < F1 < 385 | 2090 < F2 | 1950 < F3 |
| /u/-whod | 3.0 < R < 3.1 | F1 < 406 | F2 < 1200 | 1950 < F3 |
| /u/-whod | R < 3.05 | 290 < F1 < 434 | F2 < 1360 | 1800 < F3 |
| /I/-hid | 2.2 < R < 3.0 | 385 < F1 < 620 | 1667 < F2 < 2293 | 1950 < F3 |
| /U/-hood | 2.3 < R < 2.97 | 433 < F1 < 563 | 1039 < F2 < 1466 | 1950 < F3 |
| /æ/-had | 2.4 < R < 3.14 | 540 < F1 < 626 | 2015 < F2 < 2129 | 1950 < F3 |
| /I/-hid | 3.0 < R < 3.5 | 417 < F1 < 503 | 1837 < F2 < 2119 | 1950 < F3 |
| /U/-hood | 2.98 < R < 3.4 | 415 < F1 < 734 | 1017 < F2 < 1478 | 1950 < F3 |
| / [symbol] /-head | 3.01 < R < 3.41 | 541 < F1 < 588 | 1593 < F2 < 1936 | 1950 < F3 |
| /æ/-had | 3.14 < R < 3.4 | 540 < F1 < 654 | 1940 < F2 < 2129 | 1950 < F3 |
| /I/-hid | 3.5 < R < 3.97 | 462 < F1 < 525 | 1841 < F2 < 2061 | 1950 < F3 |
| /U/-hood | 3.5 < R < 4.0 | 437 < F1 < 551 | 1078 < F2 < 1502 | 1950 < F3 |
| /\hat{ }/-hud | 3.5 < R < 3.99 | 562 < F1 < 787 | 1131 < F2 < 1313 | 1950 < F3 |
| / [symbol] /-hawed | 3.5 < R < 3.99 | 651 < F1 < 690 | 887 < F2 < 1023 | 1950 < F3 |
| /æ/-had | 3.5 < R < 3.99 | 528 < F1 < 696 | 1875 < F2 < 2129 | 1950 < F3 |
| / [symbol] /-head | 3.5 < R < 3.99 | 537 < F1 < 702 | 1594 < F2 < 2144 | 1950 < F3 |
| /I/-hid | 4.0 < R < 4.3 | 457 < F1 < 523 | 1904 < F2 < 2295 | 1950 < F3 |
| /U/-hood | 4.0 < R < 4.3 | 475 < F1 < 560 | 1089 < F2 < 1393 | 1950 < F3 |
| /\hat{ }/-hud | 4.0 < R < 4.6 | 561 < F1 < 675 | 1044 < F2 < 1445 | 1950 < F3 |
| / [symbol] /-hawed | 4.0 < R < 4.67 | 651 < F1 < 749 | 909 < F2 < 1123 | 1950 < F3 |
| /æ/-had | 4.0 < R < 4.6 | 592 < F1 < 708 | 1814 < F2 < 2095 | 1950 < F3 |
| / [symbol] /-head | 4.0 < R < 4.58 | 519 < F1 < 745 | 1520 < F2 < 1967 | 1950 < F3 |
| /\hat{ }/-hud | 4.62 < R < 5.01 | 602 < F1 < 705 | 1095 < F2 < 1440 | 1950 < F3 |
| / [symbol] /-hawed | 4.67 < R < 5.0 | 634 < F1 < 780 | 985 < F2 < 1176 | 1950 < F3 |
| /æ/-had | 4.62 < R < 5.01 | 570 < F1 < 690 | 1779 < F2 < 1969 | 1950 < F3 |
| / [symbol] /-head | 4.59 < R < 4.95 | 596 < F1 < 692 | 1613 < F2 < 1838 | 1950 < F3 |
| / [symbol] /-hawed | 5.01 < R < 5.6 | 644 < F1 < 801 | 982 < F2 < 1229 | 1950 < F3 |
| /\hat{ }/-hud | 5.02 < R < 5.75 | 623 < F1 < 679 | 1102 < F2 < 1342 | 1950 < F3 |
| /\hat{ }/-hud | 5.02 < R < 5.72 | 679 < F1 < 734 | 1102 < F2 < 1342 | 1950 < F3 |
| /æ/-had | 5.0 < R < 5.5 | | 1679 < F2 < 1807 | 1950 < F3 |
| /æ/-had | 5.0 < R < 5.5 | | 1844 < F2 < 1938 | |
| / [symbol] /-head | 5.0 < R < 5.5 | | 1589 < F2 < 1811 | |
| /æ/-had | 5.0 < R < 5.5 | | 1842 < F2 < 2101 | |
| / [symbol] /-hawed | 5.5 < R < 5.95 | 680 < F1 < 828 | 992 < F2 < 1247 | 1950 < F3 |
| / [symbol] /-head | 5.5 < R < 6.1 | | 1573 < F2 < 1839 | |
| /æ/-had | 5.5 < R < 6.3 | | 1989 < F2 < 2066 | |
| / [symbol] /-head | 5.5 < R < 6.3 | | 1883 < F2 < 1989 | 2619 < F3 |
| /æ/-had | 5.5. < R < 6.3 | | 1839 < F2 < 1944 | F3 < 2688 |
| / [symbol] /-hawed | 5.95 < R < 7.13 | 685 < F1 < 850 | 960 < F2 < 1267 | 1950 < F3 |

Some sounds do not require the analysis of all parameters to successfully identify the vowel sound. For example, as can be seen from Table 5, the /er/ sound does not require the measurement of F1 for accurate identification.

Table 6 shows results of the example analysis, reflecting an overall 97.7% correct identification rate of the sounds produced by the 26 individuals in the sample, and 100% correct identification was achieved for 12 of the 26 talkers. The sounds produced by the other talkers were correctly identified over 92% of the time with 4 being identified at 96% or better.

Table 7 shows specific vowel identification accuracy data from the example. Of the nine vowels tested, five vowels were identified at 100%, two were identified over 98%, and the remaining two were identified at 87.7% and 95%.

TABLE 6
Vowel Identification Results

| Talker | Total Vowels | Total Correct | Percent Correct |
|---|---|---|---|
| 1 | 27 | 27 | 100 |
| 2 | 26 | 25 | 96.2 |
| 3 | 23 | 23 | 100 |
| 4 | 27 | 27 | 100 |
| 5 | 27 | 27 | 100 |
| 6 | 27 | 27 | 100 |
| 7 | 27 | 26 | 96.3 |
| 8 | 26 | 24 | 92.3 |
| 9 | 27 | 27 | 100 |
| 10 | 27 | 27 | 100 |
| 12 | 27 | 27 | 100 |
| 13 | 26 | 26 | 100 |
| 15 | 25 | 24 | 96 |
| 16 | 26 | 24 | 92.3 |
| 17 | 27 | 25 | 92.6 |
| 18 | 27 | 27 | 100 |
| 19 | 26 | 24 | 92.3 |
| 20 | 26 | 26 | 100 |
| 22 | 26 | 25 | 96.2 |
| 26 | 24 | 24 | 100 |
| Totals | 524 | 512 | 97.7 |

TABLE 7
Vowel Identification Results

| Vowel | Total Vowels | Total Correct | Percent Correct |
|---|---|---|---|
| heed | 60 | 60 | 100 |
| whod | 58 | 58 | 100 |
| hid | 59 | 59 | 100 |
| hood | 59 | 59 | 100 |
| heard | 58 | 58 | 100 |
| had | 57 | 56 | 98.2 |
| head | 57 | 50 | 87.7 |
| hawed | 56 | 55 | 98.2 |
| hud | 60 | 57 | 95 |
| Totals | 524 | 512 | 97.7 |

The largest source of errors in Table 5 is “head” with 7 of the 12 total errors being associated with “head”. The confusions between “head” and “had” are closely related with the errors being reversed when the order of analysis of the parameters is reversed. Table 8 shows the confusion data and further illustrates the head/had relationship. Table 8 also reflects that 100% of the errors are accounted for by neighboring vowels, with vowels confused for other vowels across categories when they possess similar F2 values.

TABLE 8
Experimental Confusion Data

| Vowels Intended | Vowels as Classified by the Waveform Model | | | | | | | |
|---|---|---|---|---|---|---|---|---|
| by Speaker | /i/-/u/ | | /I/-/U/ | | / [symbol] /-/ [symbol] / | | /æ/-/ [symbol] / | |
| /i/ | 60 | — | — | — | — | — | — | — |
| /u/ | — | 58 | — | — | — | — | — | — |
| /I/ | — | — | 59 | — | — | — | — | — |
| /U/ | — | — | — | 59 | — | — | — | — |
| / [symbol] / | — | — | 1 | — | 50 | — | 6 | — |
| / [symbol] / | — | — | — | — | — | 55 | — | 1 |
| /æ/ | — | — | — | — | 1 | — | 56 | — |
| / [symbol] / | — | — | — | 1 | — | 2 | — | 57 |

In one embodiment, the above procedures are used for speech recognition, and are applied to speech-to-text processes. Some other types of speech recognition software use a method of pattern matching against hundreds of thousands of tokens in a database, which slows down processing time. Using the above example of vowel identification, the vowel does not go through the additional step of matching a stored pattern out of thousands of representations; instead the phoneme is instead identified in substantially real time. Embodiments of WM identify vowels by recognizing the relationships between formants, which eliminates the need to store representations for use in the vowel identification portion of the process of speech recognition. By having the formula for (or key to) the identification of vowels from formants, a bulky database can be replaced by a relatively small amount of computer programming code. Computer code representing the conditional logic depicted in Table 5 is one example that improves the processing of speech waveforms, and it is not dependent upon improvements in hardware or processors, nor available memory. By freeing up a portion of the processing time needed for file identification, more processor time may be used for other tasks, such as talker identification.

In another embodiment, individual talkers are identified by analyzing, for example, vowel waveforms. The distinctive pattern created from the formant interactions can be used to identify an individual since, for example, many physical features involved in the production of vowels (vocal folds, lips, tongue, length of the oral cavity, teeth, etc.) are reflected in the sounds produced by talkers. These differences are reflected in formant frequencies and ratios discussed herein.

The ability to identify a particular talker (or the absence of a particular talker) enables particular embodiments to perform functions useful to law enforcement, such as automated identification of a criminal based on F0, F1, F2, and F3 data; reduction of the number of suspects under consideration because a speech sample is used to exclude persons who have different frequency patterns in their speech; and to distinguish between male and female suspects based on their characteristic speech frequencies.

In some embodiments, identification of a talker is achieved from analysis of the waveform from 10-15 milliseconds of vowel production.

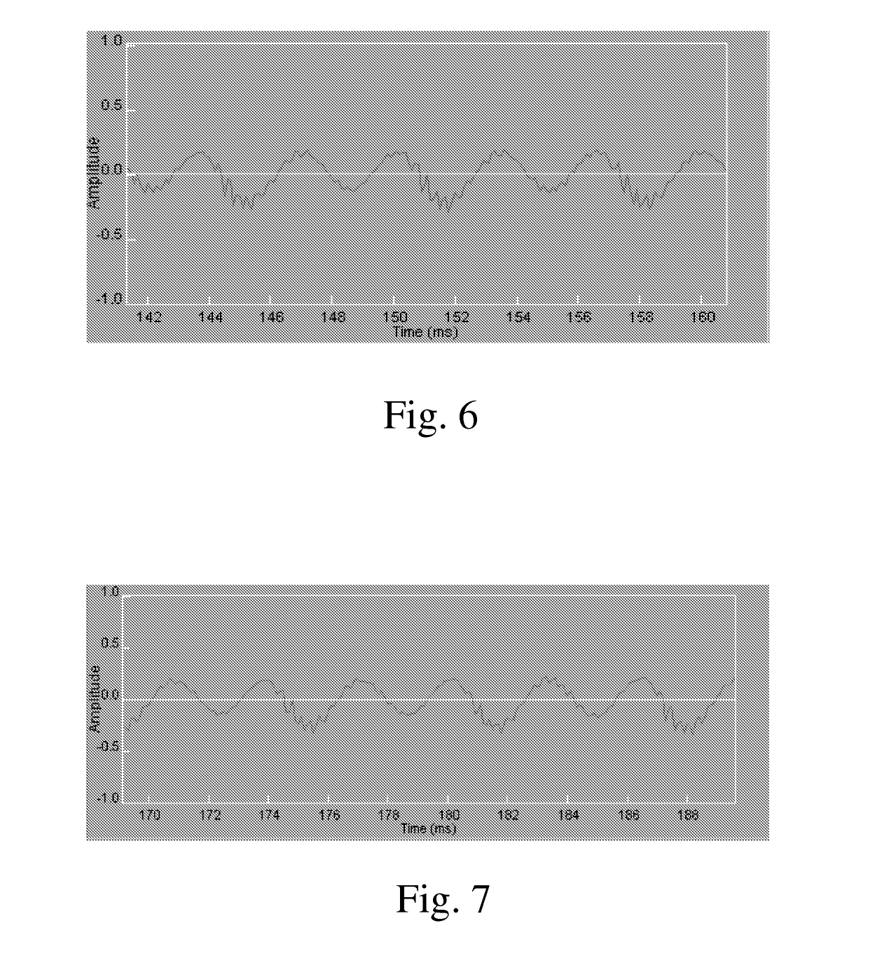

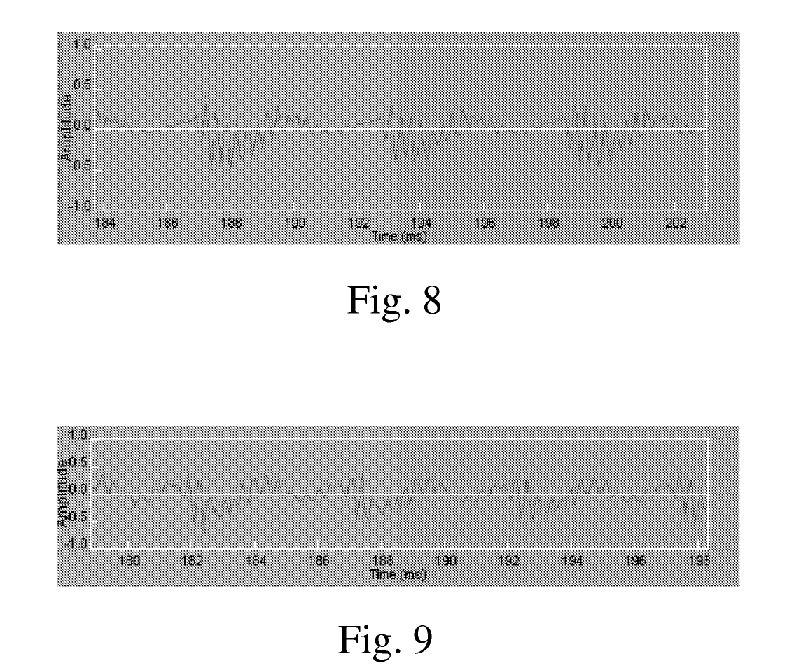

FIGS. 6-9 depict waveforms produced by different individuals that can be automatically analyzed using the system and methods described herein.

In still further embodiments, consistent recognition features can be implemented in computer recognition. For example, a 20 millisecond or longer sample of the steady state of a vowel can be stored in a database in the same way fingerprints are. In some embodiments, only the F-values are stored. This stored file is then made available for automatic comparison to another production. With vowels, the match is automated using similar technology to that used in fingerprint matching, but additional information (F0, F1, and F2 measurements, etc.) can be passed to the matching subsystem to reduce the number of false positives and add to the likelihood of making a correct match. By including the vowel sounds, an additional four points of information (or more) are available to match the talker. Some embodiments use a 20-25 millisecond sample of a vowel to identify a talker, although other embodiments will use a larger sample to increase the likelihood of correct identification, particularly by reducing false positives.

Still other embodiments provide speech recognition in the presence of noise. For example, typical broad-spectrum noise adds sound across a wide range of frequencies, but adds only a small amount to any given frequency band. F-frequencies can, therefore, still be identified in the presence of noise as peaks in the frequency spectrum of the audio data. Thus, even with noise, the audio data can be analyzed to identify vowels being spoken.

Yet further embodiments are used to increase the intelligibility of words spoken in the presence of noise by, for example, decreasing spectral tilt by increasing energy in the frequency range of F2 and F3. This mimics the reflexive changes many individuals make in the presence of noise (sometimes referred to as the Lombard Reflex). Microphones can be configured to amplify the specific frequency range that corresponds to the human Lombard response to noise. The signal going to headphones, speakers, or any audio output device can be filtered to increase the spectral energy in the bands likely to contain F0, F1, F2, and F3, and hearing aids can also be adjusted to take advantage of this effect. Manipulating a limited frequency range in this way can be more efficient, less costly, easier to implement, and more effective at increasing perceptual performance in noise.

Still further embodiments include hearing aids and other hearing-related applications such as cochlear implants. By analyzing the misperceptions of a listener, the frequencies creating the problems can be revealed. For example, if vowels with high F2 frequencies are being confused with low-F2-frequency vowels, one should be concerned with the perception of higher frequencies. If the errors are relatively consistent, a more specific frequency range can be identified as the weak area of perception. Conversely, if the errors are typical errors across neighboring vowels with similar F2 values, then the weak perceptual region would be expected below 1000 Hz (the region of F1). As such, the area of perceptual weakness can be isolated. The isolation of errors to a specific category or across two categories can provide the boundaries for the perceptual deficiencies. Hearing aids can then be adjusted to accommodate the weakest areas. Data gained from a perceptual experiment of listening to, for example, three (3) productions from one talker producing sounds, such as nine (9) American English vowels, addresses the perceptual ability of the patient in a real world communication task. Using these methods, the sound information that is unavailable to a listener during the identification of a word will be reflected in their perceptual results. This can identify a deficiency that may not be found in a non-communication task, such as listening to isolated tones. By organizing the perceptual data in a confusion matrix as in Table 3 above, the deficiency may be quickly identified. Hearing aids and applications such as cochlear implants can be adjusted to adapt for these deficiencies.

The words “head” and “had” generated some of the errors in the experimental implementation, while other embodiments of the present invention utilize the measurements of F1, F2, and F3 at the 20%, 50%, and 80% points within a vowel can help minimize, if not eliminate, these errors. Still other embodiments use transitional information associated with the transitions between sounds, which can convey identifying features before the steady-state region is achieved. The transition information can limit the set of possible phonemes in the word being spoken, which results in improved speed and accuracy.

Although the above description of one example embodiment is directed toward analyzing a vowel sound from a single point in the stable region of a vowel, other embodiments analyze sounds from the more dynamic regions. For example, in some embodiments, a 5 to 30 ms segment at the transition from a vowel to a consonant, which can provide preliminary information of the consonant as the lips and tongue move into position, is used for analysis.

Still other embodiments analyze sound duration, which can help differentiate between “head” and “had”. Analyzing sound duration can also add a dynamic element for identification (even if limited to these 2 vowels), and the dynamic nature of a sound (e.g., a vowel) can further improve performance beyond that of analyzing frequency characteristics at a single point.

By adding duration as a parameter, the errors between “head” and “had” were resolved to a 96.5% accuracy when similar waveform data to that discussed above was analyzed. Although some embodiments always consider duration, other embodiments only selectively analyze duration. It was noticed that duration analysis can introduce errors that are not encountered in a frequency-only-based analysis.

Table 9 shows the conditional logic used to identify the vowels. These conditional statements are typically processed in order, so if every condition in the statement is not met, the next conditional statement is processed until the vowel is identified. In some embodiments, if no match is found, the sound is given the identification of “no Model match” so every vowel is assigned an identity.

TABLE 9

| Vowel | F1/F0 (as R) | F1 | F2 | F3 | Dur. |
|---|---|---|---|---|---|
| /er/-heard | 2.4 < R < 5.14 | | 1172 < F2 < 1518 | F3 < 1965 | |
| /I/-hid | 2.04 < R < 2.89 | 369 < F1 < 420 | 2075 < F2 < 2162 | 1950 < F3 | |
| /I/-hid | 3.04 < R < 3.37 | 362 < F1 < 420 | 2106 < F2 < 2495 | 1950 < F3 | |
| /i/-heed | R < 3.45 | 304 < F1 < 421 | 2049 < F2 | | |
| /I/-hid | 2.0 < R < 4.1 | 362 < F1 < 502 | 1809 < F2 < 2495 | 1950 < F3 | |
| /u/-whod | 2.76 < R | 450 < F1 < 456 | F2 < 1182 | | |
| /u/-whod | R < 2.96 | 312 < F1 < 438 | F2 < 1182 | | |
| /U/-hood | 2.9 < R < 5.1 | 434 < F1 < 523 | 993 < F2 < 1264 | 1965 < F3 | |
| /u/-whod | R < 3.57 | 312 < F1 < 438 | F2 < 1300 | | |
| /U/-hood | 2.53 < R < 5.1 | 408 < F1 < 523 | 964 < F2 < 1376 | 1965 < F3 | |
| / [symbol] /-hawed | 4.4 < R < 4.82 | 630 < F1 < 637 | 1107 < F2 < 1168 | 1965 < F3 | |
| / [symbol] /-hawed | 4.4 < R < 6.15 | 610 < F1 < 665 | 1042 < F2 < 1070 | 1965 < F3 | |
| /\hat{ }/-hud | 4.18 < R < 6.5 | 595 < F1 < 668 | 1035 < F2 < 1411 | 1965 < F3 | |
| / [symbol] /-hawed | 3.81 < R < 6.96 | 586 < F1 < 741 | 855 < F2 < 1150 | 1965 < F3 | |
| /\hat{ }/-hud | 3.71 < R < 7.24 | 559 < F1 < 683 | 997 < F2 < 1344 | 1965 < F3 | |
| / [symbol] /-head | 3.8 < R < 5.9 | 516 < F1 < 623 | 1694 < F2 < 1800 | 1965 < F3 | 205 < dur < 285 |
| / [symbol] /-head | 3.55 < R < 6.1 | 510 < F1 < 724 | 1579 < F2 < 1710 | 1965 < F3 | 205 < dur < 245 |
| / [symbol] /-head | 3.55 < R < 6.1 | 510 < F1 < 686 | 1590 < F2 < 2209 | 1965 < F3 | 123 < dur < 205 |
| /æ/-had | 3.35 < R < 6.86 | 510 < F1 < 686 | 1590 < F2 < 2437 | 1965 < F3 | 245 < dur < 345 |
| / [symbol] /-head | 4.8 < R < 6.1 | 542 < F1 < 635 | 1809 < F2 < 1875 | | 205 < dur < 244 |
| /æ/-had | 3.8 < R < 5.1 | 513 < F1 < 663 | 1767 < F2 < 2142 | 1965 < F3 | 205 < dur < 245 |

When the second example waveform data was analyzed with embodiments using F0, F1, F2, and F3 measurements only, 382 out of 396 vowels were correctly identified for 96.5% accuracy. Thirteen of the 14 errors were confusions between “head” and “had.” When embodiments using F0, F1, F2, F3 and duration were used for “head” and “had,” well over half of the occurrences of vowels were correctly, easily, and quickly identified. In particular, the durations between 205 and 244 ms are associated with “head” and durations over 260 ms are associated with “had”. For the durations in the center of the duration range (between 244 and 260 ms) there may be no clear association to one vowel or the other, but the other WM parameters accurately identified these remaining productions. With the addition of duration, the number of errors occurring during the analysis of the second example waveform data was reduced to 3 vowels for 99.2% accuracy (393 out of 396).

Some embodiments analyze a waveform first for sounds that are perceived at 100% accuracy before analyzing for sounds that are perceived with less accuracy. For example, the one vowel perceived at 100% accuracy by humans may be corrected by accounting for this vowel first, the, if this vowel is not identified, accounting for the vowels perceived at 65% or less.

Example code used to analyze the second example waveform data is included in the Appendix. The parameters for the conditional statements are the source for the boundaries given in Table 9. The processing of the 64 lines of Cold Fusion and HTML code against the database with the example data and the web servers generally took around 300 ms for each of the 396 vowels analyzed.

In achieving computer speech recognition of vowels, various embodiments utilize a Fast Fourier Transform (FFT) algorithm of a waveform to provide input to the vowel recognition algorithm. A number of sampling options are available for processing the waveform, including millisecond-to-millisecond sampling or making sampling measurements at regular intervals. Particular embodiments identify and analyze a single point in time at the center of the vowels. Other embodiments sample at the 10%, 25%, 50%, 75%, and 90% points within the vowel information rather than hundreds of data points. Although the embodiments processing millisecond to millisecond provide great detail, analyzing the large amounts of information that result from this type of sampling is not always necessary, and sampling at just a few locations can save computing resources. When sampling at one location, or at a few locations, the sampling points within the vowel can be determined by natural transitions within the sound production, which can begin with the onset of voicing.

Many embodiments are compatible with other forms of sound recognition, and can help improve the accuracy or reduce the processing time associated with these other methods. For example, a method utilizing pattern matching from spectrograms can be improved by utilizing the WM categorization and identification methods. The categorization key to sounds (e.g., vowel sounds) and the associated conditional logic can be written into any algorithm regardless of the input to that algorithm.

Although the above discussion refers to the analysis of waveforms in particular, spectrograms can be similarly categorized and analyzed. Moreover, although the production of sounds, and in particular vowel sounds, in spoken English (and in particular American English) is used as an example above, embodiments of the present invention can be used to analyze and identify sounds from different languages, such as Chinese, Spanish, Hindi-Urdu, Arabic, Bengali, Portuguese, Russian, Japanese, Punjabi.

Alternate embodiments of the present invention use alternate combinations of the fundamental frequency F0, the formants F1, F2 and F3, and the duration of the vowel sound than those illustrated in the above examples. All combinations of F0, F1, F2, F3, vowel duration, and the ratio F1/F0 are contemplated as being within the scope of this disclosure. For instance, some embodiments compare F0 or F1 directly to known thresholds instead of their ratio F1/F0, while other embodiments compare F1/F0, F2 and duration to known sound data, and still other embodiments compare F1, F3 and duration. Additional formants similar to but different from F1, F2 and F3, and their combinations are also contemplated.

APPENDIX
Example Computer Code Used to Identify Vowel Sounds (written in Cold Fusion
programming language)

<!DOCTYPE HTML PUBLIC “-//W3C//DTD HTML 4.0 Transitional//EN”>
<html>
<head> <title>Waveform Model</title></head>
<body>
<cfquery name=“get_all” datasource=“male_talkersx” dbtype=“ODBC” debug=“yes”>
SELECT filename, f0, F1, F2, F3, duration from data
where filename like ‘m%’ and filename <> ‘m04eh’ and filename <> ‘m16ah’ and filename <>
‘m22aw’
and filename <> ‘m24aw’ and filename <> ‘m29aw’ and filename <> ‘m31ae’ and filename <>
‘m31aw’
and filename <> ‘m34ae’ and filename <> ‘m38ah’ and filename <> ‘m41ae’ and filename <>
‘m41ah’ and filename <> ‘m50aw’
and filename <> ‘m02uh’ and filename <> ‘m37ae’ <!--- and filename <> ‘m36eh’ --->
and filename not like ‘%ei’ and filename not like ‘%oa’ and filename not like ‘%ah’
</cfquery><table border=“1” cellspacing=“0” cellpadding=“4” align=“center”>
<tr><td colspan=“11” align=“center”><strong>Listing of items in the
database</strong></td></tr><tr>
<th>Correct</th><th>Variable Ratio</th> <th>Model Vowel</th><th>Vowel Text</th>
<th>Filename</th><th>Duration</th>
<th>F0 Value</th><th>F1 Value</th><th>F2 Value</th> <th>F3 Value</th></tr>
<cfoutput><cfset vCorrectCount = 0><cfloop query=“get_all”>
<cfset vRatio = (#F1# / #f0#)><cfset vModel_vowel = “”><cfset vF2_value =
#get_all.F2#><cfset vModel_vowel = “”>
<cfset filename_compare = “”><cfif Right(filename,2) is “ae”><cfset filename_compare =
“had”>
<cfelseif Right(filename,2) is “eh”><cfset filename_compare = “head”>
<cfelseif Right(filename,2) is “er”><cfset filename_compare = “heard”>
<cfelseif Right(filename,2) is “ih”><cfset filename_compare = “hid”>
<cfelseif Right(filename,2) is “iy”><cfset filename_compare = “heed”>
<cfelseif Right(filename,2) is “oo”><cfset filename_compare = “hood”>
<cfelseif Right(filename,2) is “uh”><cfset filename_compare = “hud”>
<cfelseif Right(filename,2) is “uw”><cfset filename_compare = “whod”>
<cfelseif Right(filename,2) is “aw”><cfset filename_compare = “hawed”>
<cfelse><cfset filename_compare = “odd”></cfif>
<cfif vRatio gte 2.4 and vRatio lte 5.14 and vF2_value gte 1172 and vF2_value lte 1518 and F3
lte 1965>
<cfset vModel_vowel = “heard”>
<cfelseif vRatio gte 2.04 and vRatio lte 2.3 and F1 gt 369 and F1 lt 420 and vF2_value gte 2075
and vF2_value lte 2162 and F3 gte 1950><cfset vModel_vowel = “hid”>
<cfelseif vRatio gte 2.04 and vRatio lte 2.89 and F1 gt 369 and F1 lt 420 and vF2_value gte 2075
and vF2_value lte 2126 and F3 gte 1950><cfset vModel_vowel = “hid”>
<cfelseif vRatio gte 3.04 and vRatio lte 3.37 and F1 gt 362 and F1 lt 420 and vF2_value gte 2106
and vF2_value lte 2495 and F3 gte 1950><cfset vModel_vowel = “hid”>
<cfelseif vRatio lte 3.45 and vF2_value gte 2049 and F1 gt 304 and F1 lt 421>
<cfset vModel_vowel = “heed”>
<cfelseif vRatio gte 2.0 and vRatio lte 4.1 and F1 gt 362 and F1 lt 502 and vF2_value gte 1809
and vF2_value lte 2495 and F3 gte 1950><cfset vModel_vowel = “hid”>
<cfelseif vRatio lt 2.76 and vF2_value lte 1182 and F1 gt 450 and F1 lt 456>
<cfset vModel_vowel = “whod”><cfelseif vRatio lt 2.96 and vF2_value lte 1182 and F1 gt 312
and F1 lt 438>
<cfset vModel_vowel = “whod”>
<cfelseif vRatio gte 2.9 and vRatio lte 5.1 and F1 gt 434 and F1 lt 523 and vF2_value gte 993
and vF2_value lte 1264 and F3 gte 1965><cfset vModel_vowel = “hood”>
<cfelseif vRatio lt 3.57 and vF2_value lte 1300 and F1 gt 312 and F1 lt 438><cfset
vModel_vowel = “whod”>
<cfelseif vRatio gte 2.53 and vRatio lte 5.1 and F1 gt 408 and F1 lt 523 and vF2_value gte 964
and vF2_value lte 1376 and F3 gte 1965><cfset vModel_vowel = “hood”>
<cfelseif vRatio gte 4.4 and vRatio lte 4.82 and F1 gt 630 and F1 lt 637 and vF2_value gte 1107
and vF2_value lte 1168 and F3 gte 1965><cfset vModel_vowel = “hawed”>
<cfelseif vRatio gte 4.4 and vRatio lte 6.15 and F1 gt 610 and F1 lt 665 and vF2_value gte 1042
and vF2_value lte 1070 and F3 gte 1965><cfset vModel_vowel = “hawed”>
<cfelseif vRatio gte 4.18 and vRatio lte 6.5 and F1 gt 595 and F1 lt 668 and vF2_value gte 1035
and vF2_value lte 1411 and F3 gte 1965><cfset vModel_vowel = “hud”>
<cfelseif vRatio gte 3.81 and vRatio lte 6.96 and F1 gt 586 and F1 lt 741 and vF2_value gte 855
and vF2_value lte 1150 and F3 gte 1965><cfset vModel_vowel = “hawed”>
<cfelseif vRatio gte 3.71 and vRatio lte 7.24 and F1 gt 559 and F1 lt 683 and vF2_value gte 997
and vF2_value lte 1344 and F3 gte 1965><cfset vModel_vowel = “hud”>
<cfelseif vRatio gte 3.8 and vRatio lte 5.9 and F1 gt 516 and F1 lt 623 and vF2_value gte 1694
and vF2_value lte 1800 and F3 gte 1965 and duration gte 205 and duration lte 285><cfset
vModel_vowel = “head”>
<cfelseif vRatio gte 3.55 and vRatio lte 6.1 and F1 gt 510 and F1 lt 724 and vF2_value gte 1579
and vF2_value lte 1710 and F3 gte 1965 and duration gte 205 and duration lte 245><cfset
vModel_vowel = “head”>
<cfelseif vRatio gte 3.55 and vRatio lte 6.1 and F1 gt 510 and F1 lt 724 and vF2_value gte 1590
and vF2_value lte 2209 and F3 gte 1965 and duration gte 123 and duration lte 205><cfset
vModel_vowel = “head”>
<cfelseif vRatio gte 3.35 and vRatio lte 6.86 and F1 gt 510 and F1 lt 686 and vF2_value gte 1590
and vF2_value lte 2437 and F3 gte 1965 and duration gte 245 and duration lte 345><cfset
vModel_vowel = “had”>
<cfelseif vRatio gte 4.8 and vRatio lte 6.1 and F1 gt 542 and F1 lt 635 and vF2_value gte 1809
and vF2_value lte 1875 and F3 gte 1965 and duration gte 205 and duration lte 244><cfset
vModel_vowel = “head”>
<cfelseif vRatio gte 3.8 and vRatio lte 5.1 and F1 gt 513 and F1 lt 663 and vF2_value gte 1767
and vF2_value lte 2142 and F3 gte 1965 and duration gte 205 and duration lte 245><cfset
vModel_vowel = “had”>
<cfelse><cfset vModel_vowel = “no model match”><cfset vRange = “no model match”>
</cfif><cfif findnocase(filename_compare,vModel_vowel) eq 1>
<cfset vCorrect = “correct”><cfelse><cfset vCorrect = “wrong”></cfif>
<cfif vCorrect eq “correct”><cfset vCorrectCount = vCorrectCount + 1>
<cfelse><cfset vCorrectCount = vCorrectCount></cfif><!--- <cfif vCorrect eq “wrong”> --->
<tr><td><cfif vCorrect eq “correct”><font color=“green”>#vCorrect#</font><cfelse>
<font color=“red”>#vCorrect#</font></cfif></td><td>#vRatio#</td><td>M-
#vModel_vowel#</td><td>#filename_compare#</td>
<td>#filename#</td><td>#duration#</td><td>#f0#</td><td>#F1#</td><td>#F2#</td><td>#F3
#</td></tr><!--- </cfif> --->
</cfloop><cfset vPercent = #vCorrectCount# / #get_all.recordcount#>
<tr><td>#vCorrectCount# /
#get_all.recordcount#</td><td>#numberformat(vPercent,“99.999”)#</td></tr></cfoutput></table>
</body>
</html>

While illustrated examples, representative embodiments and specific forms of the invention have been illustrated and described in detail in the drawings and foregoing description, the same is to be considered as illustrative and not restrictive or limiting. The description of particular features in one embodiment does not imply that those particular features are necessarily limited to that one embodiment. Features of one embodiment may be used in combination with features of other embodiments as would be understood by one of ordinary skill in the art, whether or not explicitly described as such. Exemplary embodiments have been shown and described, and all changes and modifications that come within the spirit of the invention are desired to be protected.

What is claimed is:

1. A system for identifying a spoken sound in audio data, comprising a processor and a memory in communication with the processor, the memory storing programming instructions executable by the processor to:
read audio data representing at least one spoken sound;
identify a sample location within the audio data representing at least one spoken sound;
determine a fundamental frequency F0 of the spoken sound at the sample location with the processor;
determine a first formant frequency F1 of the spoken sound at the sample location with the processor;
determine the second formant frequency F2 of the spoken sound at the sample location with the processor;
compare F0, F1, and F2 to predetermined ranges related to spoken sound parameters with the processor; and
as a function of the results of the comparison, output from the processor data that encodes the identity of a particular spoken sound.

2. The system of claim 1, wherein the programming instructions are further executable by the processor to capture the sound wave.

3. The system of claim 2, wherein the programming instructions are further executable by the processor to:
digitize the sound wave; and
create the audio data from the digitized sound wave.

4. The system of claim 1, wherein the programming instructions are further executable by the processor to:
compare the ratio F0/F1 to the existing data related to spoken sound parameters with the processor.

5. The system of claim 1, wherein the predetermined ranges related to spoken sound parameters are:

| Sound | F1/F0 (as R) | F1 | F2 |
|---|---|---|---|
| /er/-heard | 1.8 < R < 4.65 | | 1150 < F2 < 1650 |
| /i/-heed | R < 2.0 | | 2090 < F2 |
| /i/-heed | R < 3.1 | 276 < F1 < 385 | 2090 < F2 |
| /u/-whod | 3.0 < R < 3.1 | F1 < 406 | F2 < 1200 |
| /u/-whod | R < 3.05 | 290 < F1 < 434 | F2 < 1360 |
| /I/-hid | 2.2 < R < 3.0 | 385 < F1 < 620 | 1667 < F2 < 2293 |
| /U/-hood | 2.3 < R < 2.97 | 433 < F1 < 563 | 1039 < F2 < 1466 |
| /æ/-had | 2.4 < R < 3.14 | 540 < F1 < 626 | 2015 < F2 < 2129 |
| /I/-hid | 3.0 < R < 3.5 | 417 < F1 < 503 | 1837 < F2 < 2119 |
| /U/-hood | 2.98 < R < 3.4 | 415 < F1 < 734 | 1017 < F2 < 1478 |
| / [symbol] /-head | 3.01 < R < 3.41 | 541 < F1 < 588 | 1593 < F2 < 1936 |
| /æ/-had | 3.14 < R < 3.4 | 540 < F1 < 654 | 1940 < F2 < 2129 |
| /I/-hid | 3.5 < R < 3.97 | 462 < F1 < 525 | 1841 < F2 < 2061 |
| /U/-hood | 3.5 < R < 4.0 | 437 < F1 < 551 | 1078 < F2 < 1502 |
| /\hat{ }/-hud | 3.5 < R < 3.99 | 562 < F1 < 787 | 1131 < F2 < 1313 |
| / [symbol] /-hawed | 3.5 < R < 3.99 | 651 < F1 < 690 | 887 < F2 < 1023 |
| /æ/-had | 3.5 < R < 3.99 | 528 < F1 < 696 | 1875 < F2 < 2129 |
| / [symbol] /-head | 3.5 < R < 3.99 | 537 < F1 < 702 | 1594 < F2 < 2144 |
| /I/-hid | 4.0 < R < 4.3 | 457 < F1 < 523 | 1904 < F2 < 2295 |
| /U/-hood | 4.0 < R < 4.3 | 475 < F1 < 560 | 1089 < F2 < 1393 |
| /\hat{ }/-hud | 4.0 < R < 4.6 | 561 < F1 < 675 | 1044 < F2 < 1445 |
| / [symbol] /-hawed | 4.0 < R < 4.67 | 651 < F1 < 749 | 909 < F2 < 1123 |
| /æ/-had | 4.0 < R < 4.6 | 592 < F1 < 708 | 1814 < F2 < 2095 |
| / [symbol] /-head | 4.0 < R < 4.58 | 519 < F1 < 745 | 1520 < F2 < 1967 |
| /\hat{ }/-hud | 4.62 < R < 5.01 | 602 < F1 < 705 | 1095 < F2 < 1440 |
| / [symbol] /-hawed | 4.67 < R < 5.0 | 634 < F1 < 780 | 985 < F2 < 1176 |
| /æ/-had | 4.62 < R < 5.01 | 570 < F1 < 690 | 1779 < F2 < 1969 |
| / [symbol] /-head | 4.59 < R < 4.95 | 596 < F1 < 692 | 1613 < F2 < 1838 |
| / [symbol] /-hawed | 5.01 < R < 5.6 | 644 < F1 < 801 | 982 < F2 < 1229 |
| /\hat{ }/-hud | 5.02 < R < 5.75 | 623 < F1 < 679 | 1102 < F2 < 1342 |
| /\hat{ }/-hud | 5.02 < R < 5.72 | 679 < F1 < 734 | 1102 < F2 < 1342 |
| /æ/-had | 5.0 < R < 5.5 | | 1679 < F2 < 1807 |
| /æ/-had | 5.0 < R < 5.5 | | 1844 < F2 < 1938 |
| / [symbol] /-head | 5.0 < R < 5.5 | | 1589 < F2 < 1811 |
| /æ/-had | 5.0 < R < 5.5 | | 1842 < F2 < 2101 |
| / [symbol] /-hawed | 5.5 < R < 5.95 | 680 < F1 < 828 | 992 < F2 < 1247 |
| / [symbol] /-head | 5.5 < R < 6.1 | | 1573 < F2 < 1839 |
| /æ/-had | 5.5 < R < 6.3 | | 1989 < F2 < 2066 |
| / [symbol] /-head | 5.5 < R < 6.3 | | 1883 < F2 < 1989 |
| /æ/-had | 5.5. < R < 6.3 | | 1839 < F2 < 1944 |
| / [symbol] /-hawed | 5.95 < R < 7.13 | 685 < F1 < 850 | 960 < F2 < 1267 |

6. The system of claim 5, wherein the programming instructions are further executable by the processor to:
determine the third formant frequency F3 of the spoken sound at the sample location with the processor;
compare F3 to the predetermined thresholds related to spoken sound parameters with the processor.

7. The system of claim 6, wherein the predetermined thresholds related to spoken sound parameters are:

| Sound | F1/F0 (as R) | F1 | F2 | F3 |
|---|---|---|---|---|
| /er/-heard | 1.8 < R < 4.65 | | 1150 < F2 < 1650 | F3 < 1950 |
| /i/-heed | R < 2.0 | | 2090 < F2 | 1950 < F3 |
| /i/-heed | R < 3.1 | 276 < F1 < 385 | 2090 < F2 | 1950 < F3 |
| /u/-whod | 3.0 < R < 3.1 | F1 < 406 | F2 < 1200 | 1950 < F3 |
| /u/-whod | R < 3.05 | 290 < F1 < 434 | F2 < 1360 | 1800 < F3 |
| /I/-hid | 2.2 < R < 3.0 | 385 < F1 < 620 | 1667 < F2 < 2293 | 1950 < F3 |
| /U/-hood | 2.3 < R < 2.97 | 433 < F1 < 563 | 1039 < F2 < 1466 | 1950 < F3 |
| /æ/-had | 2.4 < R < 3.14 | 540 < F1 < 626 | 2015 < F2 < 2129 | 1950 < F3 |
| /I/-hid | 3.0 < R < 3.5 | 417 < F1 < 503 | 1837 < F2 < 2119 | 1950 < F3 |
| /U/-hood | 2.98 < R < 3.4 | 415 < F1 < 734 | 1017 < F2 < 1478 | 1950 < F3 |
| / [symbol] /-head | 3.01 < R < 3.41 | 541 < F1 < 588 | 1593 < F2 < 1936 | 1950 < F3 |
| /æ/-had | 3.14 < R < 3.4 | 540 < F1 < 654 | 1940 < F2 < 2129 | 1950 < F3 |
| /I/-hid | 3.5 < R < 3.97 | 462 < F1 < 525 | 1841 < F2 < 2061 | 1950 < F3 |
| /U/-hood | 3.5 < R < 4.0 | 437 < F1 < 551 | 1078 < F2 < 1502 | 1950 < F3 |
| /\hat{ }/-hud | 3.5 < R < 3.99 | 562 < F1 < 787 | 1131 < F2 < 1313 | 1950 < F3 |
| / [symbol] /-hawed | 3.5 < R < 3.99 | 651 < F1 < 690 | 887 < F2 < 1023 | 1950 < F3 |
| /æ/-had | 3.5 < R < 3.99 | 528 < F1 < 696 | 1875 < F2 < 2129 | 1950 < F3 |
| / [symbol] /-head | 3.5 < R < 3.99 | 537 < F1 < 702 | 1594 < F2 < 2144 | 1950 < F3 |
| /I/-hid | 4.0 < R < 4.3 | 457 < F1 < 523 | 1904 < F2 < 2295 | 1950 < F3 |
| /U/-hood | 4.0 < R < 4.3 | 475 < F1 < 560 | 1089 < F2 < 1393 | 1950 < F3 |
| /\hat{ }/-hud | 4.0 < R < 4.6 | 561 < F1 < 675 | 1044 < F2 < 1445 | 1950 < F3 |
| / [symbol] /-hawed | 4.0 < R < 4.67 | 651 < F1 < 749 | 909 < F2 < 1123 | 1950 < F3 |
| /æ/-had | 4.0 < R < 4.6 | 592 < F1 < 708 | 1814 < F2 < 2095 | 1950 < F3 |
| / [symbol] /-head | 4.0 < R < 4.58 | 519 < F1 < 745 | 1520 < F2 < 1967 | 1950 < F3 |
| /\hat{ }/-hud | 4.62 < R < 5.01 | 602 < F1 < 705 | 1095 < F2 < 1440 | 1950 < F3 |
| / [symbol] /-hawed | 4.67 < R < 5.0 | 634 < F1 < 780 | 985 < F2 < 1176 | 1950 < F3 |
| /æ/-had | 4.62 < R < 5.01 | 570 < F1 < 690 | 1779 < F2 < 1969 | 1950 < F3 |
| / [symbol] /-head | 4.59 < R < 4.95 | 596 < F1 < 692 | 1613 < F2 < 1838 | 1950 < F3 |
| / [symbol] /-hawed | 5.01 < R < 5.6 | 644 < F1 < 801 | 982 < F2 < 1229 | 1950 < F3 |
| /\hat{ }/-hud | 5.02 < R < 5.75 | 623 < F1 < 679 | 1102 < F2 < 1342 | 1950 < F3 |
| /\hat{ }/-hud | 5.02 < R < 5.72 | 679 < F1 < 734 | 1102 < F2 < 1342 | 1950 < F3 |
| /æ/-had | 5.0 < R < 5.5 | | 1679 < F2 < 1807 | 1950 < F3 |
| /æ/-had | 5.0 < R < 5.5 | | 1844 < F2 < 1938 | |
| / [symbol] /-head | 5.0 < R < 5.5 | | 1589 < F2 < 1811 | |
| /æ/-had | 5.0 < R < 5.5 | | 1842 < F2 < 2101 | |
| / [symbol] /-hawed | 5.5 < R < 5.95 | 680 < F1 < 828 | 992 < F2 < 1247 | 1950 < F3 |
| / [symbol] /-head | 5.5 < R < 6.1 | | 1573 < F2 < 1839 | |
| /æ/-had | 5.5 < R < 6.3 | | 1989 < F2 < 2066 | |
| / [symbol] /-head | 5.5 < R < 6.3 | | 1883 < F2 < 1989 | 2619 < F3 |
| /æ/-had | 5.5. < R < 6.3 | | 1839 < F2 < 1944 | F3 < 2688 |
| / [symbol] /-hawed | 5.95 < R < 7.13 | 685 < F1 < 850 | 960 < F2 < 1267 | 1950 < F3 |

8. The system of claim 1, wherein the programming instructions are further executable by the processor to:
determine the duration of the spoken sound with the processor;
compare the duration of the spoken sound to the predetermined thresholds related to spoken sound parameters with the processor.

9. The system of claim 8, wherein the predetermined spoken sound parameters are:

| Sound | F1/F0 (as R) | F1 | F2 | Dur. |
|---|---|---|---|---|
| /er/-heard | 2.4 < R < 5.14 | | 1172 < F2 < 1518 | |
| /I/-hid | 2.04 < R < 2.89 | 369 < F1 < 420 | 2075 < F2 < 2162 | |
| /I/-hid | 3.04 < R < 3.37 | 362 < F1 < 420 | 2106 < F2 < 2495 | |
| /i/-heed | R < 3.45 | 304 < F1 < 421 | 2049 < F2 | |
| /I/-hid | 2.0 < R < 4.1 | 362 < F1 < 502 | 1809 < F2 < 2495 | |
| /u/-whod | 2.76 < R | 450 < F1 < 456 | F2 < 1182 | |
| /u/-whod | R < 2.96 | 312 < F1 < 438 | F2 < 1182 | |
| /U/-hood | 2.9 < R < 5.1 | 434 < F1 < 523 | 993 < F2 < 1264 | |
| /u/-whod | R < 3.57 | 312 < F1 < 438 | F2 < 1300 | |
| /U/-hood | 2.53 < R < 5.1 | 408 < F1 < 523 | 964 < F2 < 1376 | |
| / [symbol] /-hawed | 4.4 < R < 4.82 | 630 < F1 < 637 | 1107 < F2 < 1168 | |
| / [symbol] /-hawed | 4.4 < R < 6.15 | 610 < F1 < 665 | 1042 < F2 < 1070 | |
| /\hat{ }/-hud | 4.18 < R < 6.5 | 595 < F1 < 668 | 1035 < F2 < 1411 | |
| / [symbol] /-hawed | 3.81 < R < 6.96 | 586 < F1 < 741 | 855 < F2 < 1150 | |
| /\hat{ }/-hud | 3.71 < R < 7.24 | 559 < F1 < 683 | 997 < F2 < 1344 | |
| / [symbol] /-head | 3.8 < R < 5.9 | 516 < F1 < 623 | 1694 < F2 < 1800 | 205 < dur < 285 |
| / [symbol] /-head | 3.55 < R < 6.1 | 510 < F1 < 724 | 1579 < F2 < 1710 | 205 < dur < 245 |
| / [symbol] /-head | 3.55 < R < 6.1 | 510 < F1 < 686 | 1590 < F2 < 2209 | 123 < dur < 205 |
| /æ/-had | 3.35 < R < 6.86 | 510 < F1 < 686 | 1590 < F2 < 2437 | 245 < dur < 345 |
| / [symbol] /-head | 4.8 < R < 6.1 | 542 < F1 < 635 | 1809 < F2 < 1875 | 205 < dur < 244 |
| /æ/-had | 3.8 < R < 5.1 | 513 < F1 < 663 | 1767 < F2 < 2142 | 205 < dur < 245 |

10. The system of claim 1, wherein the programming instructions are further executable by the processor to:
identify as the sample location within the audio data the period within 10 milliseconds of the center of the spoken sound.

11. The system of claim 1, wherein the programming instructions are further executable by the processor to:
transform audio samples into frequency spectrum data when determining the fundamental frequency F0, the first formant F1, and the second formant F2.

12. The system of claim 1, wherein the sample location within the audio data represents least one vowel sound.

13. The system of claim 1, wherein the programming instructions are further executable by the processor to identify an individual by comparing F0, F1 and F2 from the individual to calculated F0, F1 and F2 from an earlier audio sampling.

14. The system of claim 1, wherein the programming instructions are further executable by the processor to identify multiple speakers in the audio data by comparing F0, F1 and F2 from multiple instances of spoken sound utterances in the audio data.

15. A method for identifying a vowel sound, comprising the acts of:
identifying a sample time location within the vowel sound;
measuring the fundamental frequency F0 of the vowel sound at the sample time location;
measuring the first formant F1 of the vowel sound at the sample time location;
measuring the second formant F2 of the vowel sound at the sample time location; and
determining one or more vowel sounds to which F0, F1, and F2 correspond by comparing F0, F1, and F2 to predetermined thresholds.

16. The system of claim 15, further comprising determining one or more vowel sounds to which F2 and the ratio F0/F1 correspond by comparing F2 and the ratio F0/F1 to predetermined thresholds.

17. The method of claim 15, wherein the predetermined vowel thresholds are:

| Vowel | F1/F0 (as R) | F1 | F2 |
|---|---|---|---|
| /er/-heard | 1.8 < R < 4.65 | | 1150 < F2 < 1650 |
| /i/-heed | R < 2.0 | | 2090 < F2 |
| /i/-heed | R < 3.1 | 276 < F1 < 385 | 2090 < F2 |
| /u/-whod | 3.0 < R < 3.1 | F1 < 406 | F2 < 1200 |
| /u/-whod | R < 3.05 | 290 < F1 < 434 | F2 < 1360 |
| /I/-hid | 2.2 < R < 3.0 | 385 < F1 < 620 | 1667 < F2 < 2293 |
| /U/-hood | 2.3 < R < 2.97 | 433 < F1 < 563 | 1039 < F2 < 1466 |
| /æ/-had | 2.4 < R < 3.14 | 540 < F1 < 626 | 2015 < F2 < 2129 |
| /I/-hid | 3.0 < R < 3.5 | 417 < F1 < 503 | 1837 < F2 < 2119 |
| /U/-hood | 2.98 < R < 3.4 | 415 < F1 < 734 | 1017 < F2 < 1478 |
| / [symbol] /-head | 3.01 < R < 3.41 | 541 < F1 < 588 | 1593 < F2 < 1936 |
| /æ/-had | 3.14 < R < 3.4 | 540 < F1 < 654 | 1940 < F2 < 2129 |
| /I/-hid | 3.5 < R < 3.97 | 462 < F1 < 525 | 1841 < F2 < 2061 |
| /U/-hood | 3.5 < R < 4.0 | 437 < F1 < 551 | 1078 < F2 < 1502 |
| /\hat{ }/-hud | 3.5 < R < 3.99 | 562 < F1 < 787 | 1131 < F2 < 1313 |
| / [symbol] /-hawed | 3.5 < R < 3.99 | 651 < F1 < 690 | 887 < F2 < 1023 |
| /æ/-had | 3.5 < R < 3.99 | 528 < F1 < 696 | 1875 < F2 < 2129 |
| / [symbol] /-head | 3.5 < R < 3.99 | 537 < F1 < 702 | 1594 < F2 < 2144 |
| /I/-hid | 4.0 < R < 4.3 | 457 < F1 < 523 | 1904 < F2 < 2295 |
| /U/-hood | 4.0 < R < 4.3 | 475 < F1 < 560 | 1089 < F2 < 1393 |
| /\hat{ }/-hud | 4.0 < R < 4.6 | 561 < F1 < 675 | 1044 < F2 < 1445 |
| / [symbol] /-hawed | 4.0 < R < 4.67 | 651 < F1 < 749 | 909 < F2 < 1123 |
| /æ/-had | 4.0 < R < 4.6 | 592 < F1 < 708 | 1814 < F2 < 2095 |
| / [symbol] /-head | 4.0 < R < 4.58 | 519 < F1 < 745 | 1520 < F2 < 1967 |
| /\hat{ }/-hud | 4.62 < R < 5.01 | 602 < F1 < 705 | 1095 < F2 < 1440 |
| / [symbol] /-hawed | 4.67 < R < 5.0 | 634 < F1 < 780 | 985 < F2 < 1176 |
| /æ/-had | 4.62 < R < 5.01 | 570 < F1 < 690 | 1779 < F2 < 1969 |
| / [symbol] /-head | 4.59 < R < 4.95 | 596 < F1 < 692 | 1613 < F2 < 1838 |
| / [symbol] /-hawed | 5.01 < R < 5.6 | 644 < F1 < 801 | 982 < F2 < 1229 |
| /\hat{ }/-hud | 5.02 < R < 5.75 | 623 < F1 < 679 | 1102 < F2 < 1342 |
| /\hat{ }/-hud | 5.02 < R < 5.72 | 679 < F1 < 734 | 1102 < F2 < 1342 |
| /æ/-had | 5.0 < R < 5.5 | | 1679 < F2 < 1807 |
| /æ/-had | 5.0 < R < 5.5 | | 1844 < F2 < 1938 |
| / [symbol] /-head | 5.0 < R < 5.5 | | 1589 < F2 < 1811 |
| /æ/-had | 5.0 < R < 5.5 | | 1842 < F2 < 2101 |
| / [symbol] /-hawed | 5.5 < R < 5.95 | 680 < F1 < 828 | 992 < F2 < 1247 |
| / [symbol] /-head | 5.5 < R < 6.1 | | 1573 < F2 < 1839 |
| /æ/-had | 5.5 < R < 6.3 | | 1989 < F2 < 2066 |
| / [symbol] /-head | 5.5 < R < 6.3 | | 1883 < F2 < 1989 |
| /æ/-had | 5.5. < R < 6.3 | | 1839 < F2 < 1944 |
| / [symbol] /-hawed | 5.95 < R < 7.13 | 685 < F1 < 850 | 960 < F2 < 1267 |

18. The method of claim 17, further comprising:
measuring the third formant F3 of the vowel sound at the sample time location;
measuring the duration of the vowel sound at the sample time location;
determining one or more vowel sounds to which F0, F1, F2, F3, and the duration of the vowel sound correspond by comparing F0, F1, F2, F3, and the duration of the vowel sound to predetermined thresholds.

19. The method of claim 18, wherein the predetermined vowel sound parameters are:

| Vowel | F1/F0 (as R) | F1 | F2 | F3 | Dur. |
|---|---|---|---|---|---|
| /er/-heard | 2.4 < R < 5.14 | | 1172 < F2 < 1518 | F3 < 1965 | |
| /I/-hid | 2.04 < R < 2.89 | 369 < F1 < 420 | 2075 < F2 < 2162 | 1950 < F3 | |
| /I/-hid | 3.04 < R < 3.37 | 362 < F1 < 420 | 2106 < F2 < 2495 | 1950 < F3 | |
| /i/-heed | R < 3.45 | 304 < F1 < 421 | 2049 < F2 | | |
| /I/-hid | 2.0 < R < 4.1 | 362 < F1 < 502 | 1809 < F2 < 2495 | 1950 < F3 | |
| /u/-whod | 2.76 < R | 450 < F1 < 456 | F2 < 1182 | | |
| /u/-whod | R < 2.96 | 312 < F1 < 438 | F2 < 1182 | | |
| /U/-hood | 2.9 < R < 5.1 | 434 < F1 < 523 | 993 < F2 < 1264 | 1965 < F3 | |
| /u/-whod | R < 3.57 | 312 < F1 < 438 | F2 < 1300 | | |
| /U/-hood | 2.53 < R < 5.1 | 408 < F1 < 523 | 964 < F2 < 1376 | 1965 < F3 | |
| / [symbol] /-hawed | 4.4 < R < 4.82 | 630 < F1 < 637 | 1107 < F2 < 1168 | 1965 < F3 | |
| / [symbol] /-hawed | 4.4 < R < 6.15 | 610 < F1 < 665 | 1042 < F2 < 1070 | 1965 < F3 | |
| /\hat{ }/-hud | 4.18 < R < 6.5 | 595 < F1 < 668 | 1035 < F2 < 1411 | 1965 < F3 | |
| / [symbol] /-hawed | 3.81 < R < 6.96 | 586 < F1 < 741 | 855 < F2 < 1150 | 1965 < F3 | |
| /\hat{ }/-hud | 3.71 < R < 7.24 | 559 < F1 < 683 | 997 < F2 < 1344 | 1965 < F3 | |
| / [symbol] /-head | 3.8 < R < 5.9 | 516 < F1 < 623 | 1694 < F2 < 1800 | 1965 < F3 | 205 < dur < 285 |
| / [symbol] /-head | 3.55 < R < 6.1 | 510 < F1 < 724 | 1579 < F2 < 1710 | 1965 < F3 | 205 < dur < 245 |
| / [symbol] /-head | 3.55 < R < 6.1 | 510 < F1 < 686 | 1590 < F2 < 2209 | 1965 < F3 | 123 < dur < 205 |
| /æ/-had | 3.35 < R < 6.86 | 510 < F1 < 686 | 1590 < F2 < 2437 | 1965 < F3 | 245 < dur < 345 |
| / [symbol] /-head | 4.8 < R < 6.1 | 542 < F1 < 635 | 1809 < F2 < 1875 | | 205 < dur < 244 |
| /æ/-had | 3.8 < R < 5.1 | 513 < F1 < 663 | 1767 < F2 < 2142 | 1965 < F3 | 205 < dur < 245 |

20. A system for identifying a spoken sound in audio data, comprising a processor and a memory in communication with the processor, the memory storing programming instructions executable by the processor to:
read audio data representing at least one spoken sound;
repeatedly
identify a potential sample location within the audio data representing at least one spoken sound; and
determine a fundamental frequency F0 of the spoken sound at the potential sample location with the processor;
until F0 is within a predetermined range, each time changing the potential sample;
set the sample location at the potential sample location;
determine a first formant frequency F1 of the spoken sound at the sample location with the processor;
determine the second formant frequency F2 of the spoken sound at the sample location with the processor;
compare F0, F1, and F2 to existing threshold data related to spoken sound parameters with the processor; and
as a function of the results of the comparison, output from the processor data that encodes the identity of a particular spoken sound.
